(19) United States
(12) Patent Application Publication
(10) Pub. No.: US 2010/0278061 A1
(43) Pub. Date: Nov. 4, 2010

(54) CINR FORMULA FOR SPATIAL MULTIPLEXING

(75) Inventors: Doron Ezri, Tel Aviv (IL); Oded Redlich, Ramat Hasharon (IL)

Correspondence Address: ROBERT G. LEV, 4766 MICHIGAN BLVD., YOUNGSTOWN, OH, 44505, US

(73) Assignee: RUNCOM TECHNOLOGIES LTD., RISHON LEZION (IL)

(21) Appl. No.: 12/735,347

(22) PCT Filed: Jan. 6, 2009
(86) PCT No.: PCT/IB2009/050027

§ 371 Date: Jul. 7, 2010

Related U.S. Application Data
(60) Provisional application No. 61/019,313, filed on Jan. 7, 2008.

(51) Int. Cl. H04W 24/00; H04B 17/00; H04L 12/26

(52) U.S. Cl. 370/252; 375/224

(57) ABSTRACT

A method for calculating channel quality in a multi-stream communication system, by calculating channel quality for each selectable stream of the multi-stream communication system, based on estimation of at lest one set of error vectors.

### CROSS-REFERENCE TO RELATED APPLICATIONS

The present application claims priority from U.S. provisional patent application 61/019,313, filed Jan. 7, 2008, the contents of which are hereby incorporated by reference.

### FIELD AND BACKGROUND OF THE INVENTION

The present invention relates to communication systems and methods, and, particularly, to multiple-input-multiple-output (MIMO) communication system and methods.

Carrier to Interference-plus-Noise Ratio (CINR) is an important parameter for any communication system and/or method, and it is particularly difficult to estimate CINR for communication system and methods using multiple-input-multiple-output (MIMO).

In contrast to other transmission and reception schemes, in maximum likelihood (ML) decoded spatial multiplexing (SM), the per-tone post processing CINR is trivial. The formula adopted in the IEEE802.16e for ML decoded vertical SM is provided by Eq. 1:

$$C I N R = {e}^{c} - 1 where \\ C = logdet ( I + \frac{{HH}^{*}}{{ρ}^{2}} ) where \qquad Eq . 1$$

H is the per tone channel matrix; and
ρ² is the variance of the interference plus noise.
Eq. 1 is problematic in two ways:

(1) Eq. 1 gives erroneous results when the matrix H features high correlation. For instance, in the case represented by Eq. 2:

$$H = [ \begin{matrix}1 & 0 \\ 1 & 0\end{matrix} ] \qquad Eq . 2$$

Obviously, the CINR in vertical SM should vanish (on a linear scale), since half the measurements are not decodable. However, Eq. 1 does not capture this behavior.

(2) Eq. 1 cannot be modified in a simple manner to accommodate horizontal SM, where multiple CINR estimates are to be produced (one for each stream), as in uplink (UL) collaborative MIMO.

The following US patent applications are believed to represent the most relevant prior art: 20060030364, 20070058603, 20070201568, 20070248151, 20070274409, 20080080459, 20080080634, 20080186915, and 20080240217.

The present invention provides a different formula for ML decoded SM that remedies to aforementioned problems. The proposed method gives a much more accurate CINR estimate that allows superior link mode selection, link adaptation, etc. There is thus a widely recognized need for, and it would be highly advantageous to have, a CINR estimation method and/or system devoid of the above limitations.

### SUMMARY OF THE INVENTION

According to one aspect of the present invention there is provided a method for calculating channel quality in a multi-stream communication system, the method including the step of calculating the channel quality for a selectable stream of the multi-stream communication system.

According to another aspect of the present invention there is provided a method for assigning a plurality of transmitters to a frequency-time resource in a multi-stream communication system, the method including the steps of: calculating single-stream channel quality for a plurality of selectable streams of the multi-stream communication system, selecting a frequency-time resource, and assigning a plurality of transmitters to the frequency-time resource according to their channel quality.

According to yet another aspect of the present invention there is provided a method for calculating channel quality additionally including estimating at lest one set of error vectors including at least one transmission vector including at least one erroneous element, and where the step of calculating the channel quality uses the estimation of at lest one set of error vectors.

According to still another aspect of the present invention there is provided a method for calculating channel quality where the element includes at least one of a bit, a baud, and a symbol.

Also according to another aspect of the present invention there is provided a method for calculating channel quality where the channel quality includes signal to noise ratio (SNR), or Carrier to Interference-plus-Noise Ratio (CINR), or Signal to Interference-plus-Noise Ratio (SINR).

Additionally according to still another aspect of the present invention there is provided a method for calculating channel quality where the receiver receives the multi-stream signal in the uplink and/or in the downlink.

Further according to another aspect of the present invention there is provided a method for calculating channel quality where the multi-stream communication system includes a Multi-Input-Multi-Output (MIMO) technology, and/or a spatial diversity technology, and/or a spatial multiplexing technology.

Further according to another aspect of the present invention there is provided a method for calculating channel quality where the step of calculating the channel quality includes calculating sets of values corresponding to errors in each stream, and/or constructing at lest one set of error vectors (Âᵢ) from the values.

Yet further according to another aspect of the present invention there is provided a method for calculating channel quality where the step of calculating the channel quality includes the steps of estimating channel response for each antenna, and constructing channel matrix (H) from the channel responses.

Even further according to another aspect of the present invention there is provided a method for calculating channel quality where the step of calculating the channel quality includes calculating a set of values H·e for the i-th stream, where e denotes a matrix element of the error matrix Âᵢ, and calculating the CINR for the selectable stream i according to

$$C I N {R}_{i} ( H ) = {min}_{e ∈ {\hat{A}}_{i}} \frac{{‖ He ‖}^{2}}{2 {ρ}^{2}}$$

Also according to another aspect of the present invention there is provided a method for calculating channel quality where the multi-stream communication system includes a plurality of user terminals, where each of the user-terminals transmits a single stream, and where the multi-stream signal includes the single streams transmitted by the plurality of user-terminals.

Additionally according to another aspect of the present invention there is provided a method for calculating channel quality where at least two of the plurality of user-terminals use the same frequency-time resource.

According to yet another aspect of the present invention there is provided a method for calculating channel quality additionally including the steps of selecting the user-terminals using the same frequency-time resources, and/or selecting the frequency-time resources for use by the plurality of user-terminals.

According to still another aspect of the present invention there is provided a method for calculating channel quality where the receiver performs at least one of the additional steps described above.

Further according to another aspect of the present invention there is provided a method for calculating channel quality where the channel quality is calculated for a plurality of channels in a vertical spatial multiplexing situation, and where the step of calculating the channel quality includes the steps of calculating a set of values H·e for the i-th stream, where e denotes a matrix element of the error matrix Âᵢ and calculating the CINR for the selectable stream i according to

CINR(H)=min[CINR₀(H),CINR₁(H)]

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may varied without changing the purpose or effect of the methods described.

Implementation of the method and system of the present invention involves performing or completing certain selected tasks or steps manually, automatically, or any combination thereof. Moreover, according to actual instrumentation and equipment of preferred embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A and 1B are simplified illustrations of two configurations of a MIMO communication system equipped with CINR estimator;

FIGS. 2A, 2B, 2C, and 2D are graphical illustration of transitions in the set of error-vector Aᵢ in a configuration of the MIMO communication system equipped with CINR estimator;

FIG. 3 is a simplified graphical illustration of CINR metrics according to a preferred embodiment of the present invention compared with standard CINR; and

FIG. 4 is a simplified graphical illustration of CINR accuracy for QAM16.

### DESCRIPTION OF THE PREFERRED EMBODIMENTS

The principles and operation of a method and system for calculating Carrier to Interference-plus-Noise Ratio (CINR), or Signal to Noise Ration (SNR), or Signal to Interference plus noise ratio (SINR), for a data stream in a Multi-Input-Multi-Output (MIMO) system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The CINR formula of the present invention is intended to overcome limitations of the systems currently known in the art as described by the set of Eqs. 3, 4 and 5:

$$\begin{matrix}C = ln ( 1 + S N R ) & Eq . 3 \\ C = \frac{1}{m} ln det ( I + \frac{{HH}^{*}}{{ρ}^{2}} ) & Eq . 4 \\ C I N R = {e}^{c} - 1 & Eq . 5\end{matrix}$$

Eqs. 3, 4 and 5 are effective when there is no correlation between the data streams and the calculation of the CINR is performed on the pre-processed received signal, that is, before demodulation. However, when there is correlation between the streams the calculation of the CINR should be performed on the post-processed signal, that is after the demodulation. In this case the CINR calculation as described by Eqs. 3, 4 and 5 is erroneous. The CINR calculation described below describes a method for calculating CINR on the post-processed, or the demodulated, signal.

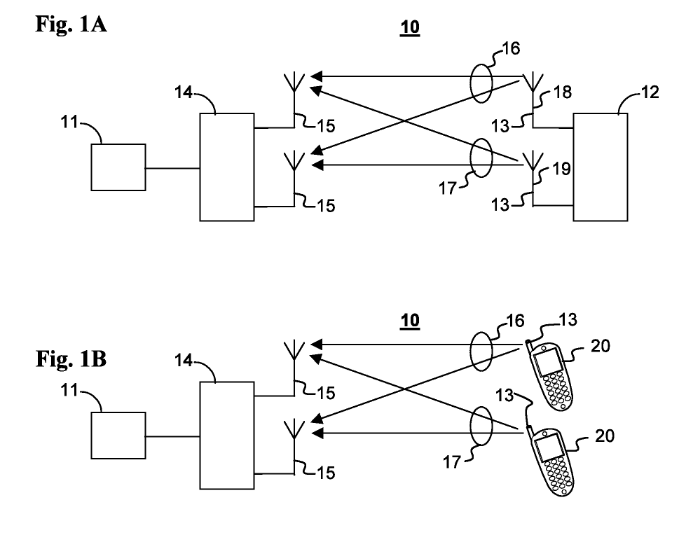

Reference is now made to FIGS. 1A and 1B, which are simplified illustrations of two configurations of a MIMO communication system 10 equipped with CINR estimator 11, according to a preferred embodiment of the present invention.

FIG. 1A shows a MIMO communication system 10 including a transmitter station 12 (which can be a transceiver station) equipped with two transmission antennas 13, and a receiver station 14 (which can be a transceiver station), equipped with two receiving antennas 15. The MIMO communication system 10 uses a 2×2 MIMO antenna system. It is appreciated that the MIMO antenna system may include N×M antennas, where N and M are arbitrary numbers greater than 1. Typically, the MIMO communication system of FIG. 1A can generate up to min[M,N] streams. In the [2×2] system of FIG. 1A there are two streams 16 and 17. The transmission is termed “horizontal” for two data streams, one via antenna 18 and the other via antenna 19. The transmission is termed “vertical” if the two data streams are alternating between antennas 18 and 19.

FIG. 1B shows another configuration of the MIMO communication system 10, including a plurality of transmitter stations 20 (each of which can be a transceiver station) and a receiver station 14 (which can be a transceiver station too). Each of the transmitter stations 20 contains a single antenna 13. Like the configuration of FIG. 1A, the configuration of FIG. 1B includes the two streams 16 and 17 in horizontal mode.

In the MIMO communication system 10 of both FIGS. 1A and 1B the receiver station 14 is typically a base-station. In both the MIMO communication system 10 of FIGS. 1A and 1B the receiver station 14 is equipped with the CINR estimator 11.

We consider the following mathematical model for the per tone received N×1 signal vector y in SM, is represented by Eq. 6:

y=Hs+ρn Eq. 6:

where
H is the N×M channel matrix;
S is the M×1 transmitted vector retaining the information sent from M different user terminals (UTs),
ρ is the interference and noise intensity; and
n is the N×1 interference and noise vector assumed additive white Gaussian noise (AWGN) for the simplicity of the derivation.

The optimal ML MIMO decoder is best described by the expression for the log-likelihood ratio (LLR) of each transmitted bit is represented by Eq. 7:

$$L L R ( b ) = \frac{1}{{ρ}^{2}} [ - {min}_{ξ : b = 1} {‖ y - H ξ ‖}^{2} + {min}_{ξ : b = 0} {‖ y - H ξ ‖}^{2} ] \qquad Eq . 7$$

Therefore, in uncoded systems the ML estimator Ŝ for the transmitted vector S is represented by Eq. 7:

$$\hat{s} = {min}_{ξ ∈ {QAM}^{2}} {‖ y - H ξ ‖}^{2} \qquad Eq . 8$$

An error event is preferably defined herein by Eq. 9 in a manner that distinguishes the event of error in s₀ from error in s₁:

Pr(error in sᵢ)=Pr(ŝεBᵢ) Eq. 9:

where:
Bᵢ contains all the transmitted vectors in which the I-th element (e.g. bit, baud, and/or symbol) is erroneous, and
ŝ is the estimated data vector.

Applying the union bound, the per stream error probability is bounded by Eq. 10:

$$Pr ( error in {s}_{i} ) = {\sum }_{ξ ∈ {B}_{i}} Pr ( {‖ y - H ξ ‖}^{2} < {‖ y - H s ‖}^{2} ) \qquad Eq . 10$$

Using Eq. 6 and some standard high (pre processing) CINR approximations leads to Eq. 11:

$$Pr ( error in {s}_{i} ) = {C}_{1} {\sum }_{e ∈ {A}_{i}} exp ( - \frac{{‖ He ‖}^{2}}{4 {ρ}^{2}} ) where \qquad Eq . 11$$

e=ξ−S is the error vector; and
Aᵢ is the set of all vectors e that correspond to the set Bᵢ.

The error probability may be further simplified through the max-log approximation as described by Eq. 12:

$$Pr ( error in {s}_{i} ) = {C}_{1} exp ( - {min}_{e ∈ {A}_{i}} \frac{{‖ He ‖}^{2}}{4 {ρ}^{2}} ) \qquad Eq . 12$$

Continuing, without loss of generality, with QPSK modulation, and bearing in mind that in QPSK the CINR estimate should satisfy Eq. 13:

$$Pr ( error in {s}_{i} ) = {C}_{2} exp ( - \frac{{CINR}_{i} ( H )}{2} ) \qquad Eq . 13$$

Equating the exponentials of Eqs. 12 and 13 gives the approximation described by Eq. 14:

$${CINR}_{i} ( H ) = {min}_{e ∈ A} \frac{{‖ He ‖}^{2}}{2 {ρ}^{2}} \qquad Eq . 14$$

At this point we turn to the determination of the sets Aᵢ. To keep the exposition simple we consider the case of 2 spatial streams. An error in S₀ means that the first component in e is nonzero, and may assume any value corresponding to a transition to any other constellation point in the QAM that differs from S₀. Moreover, the second component in e may assume any value corresponding to a transition to any other constellation point including zero (zero means that there is no error in S₁).

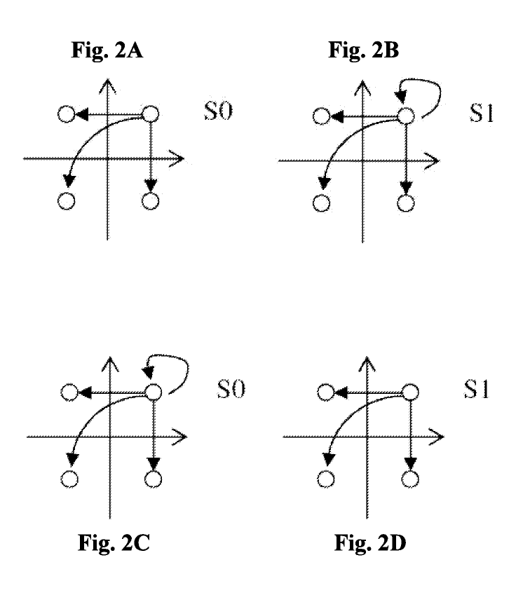

Reference is now made to FIGS. 2A, 2B, 2C, and 2D, which are graphical illustration of transitions in the set of error-vector Aᵢ, according to a preferred embodiment of the present invention.

FIG. 2A shows the transitions in the set A₀ when

$$\frac{1 + j}{\sqrt{2}}$$

is transmitted in s₀.

FIG. 2B shows the transitions in the set A₀ when

$$\frac{1 + j}{\sqrt{2}}$$

is transmitted in s₁.

FIG. 2C shows the transitions in the set A₁ when

$$\frac{1 + j}{\sqrt{2}}$$

is transmitted in s₀.

FIG. 2D shows the transitions in the set A₁ when

$$\frac{1 + j}{\sqrt{2}}$$

is transmitted in s₁.

In QPSK the set A₀ takes the form of Eq. 15:

$${A}_{0} = \sqrt{2} \{ \begin{matrix}[ \frac{1}{0} ] , [ \frac{- 1}{0} ] , [ \frac{j}{0} ] , [ \frac{- j}{0} ] , … , \\ [ \frac{- 1}{1} ] , [ \frac{- 1}{1} ] , [ \frac{j}{1} ] , [ \frac{- j}{1} ] , [ \frac{1}{- 1} ]\end{matrix} \} \qquad Eq . 15$$

It is appreciated that many of the elements in the set A₀ are redundant as they lead to the same value of the cost functional ∥He∥.

The first four elements of A₀ are an example, and so are the vectors \sqrt{2}[1,−1]^{T},\sqrt{2}[−1,1]^{T}.

Removing redundant elements and neglecting vectors that correspond to far transitions, the sets A₀ and A₁ may be approximated by the set of Eqs. 16:

$${\hat{A}}_{0} = \sqrt{2} \{ \begin{matrix}[ \frac{1}{0} ] , [ \frac{1}{1} ] , [ \frac{- 1}{1} ] , [ \frac{j}{1} ] , \\ [ \frac{- j}{1} ] , [ \frac{1 + j}{1} ] , [ \frac{1 - j}{1} ] , [ \frac{- 1 + j}{1} ] , [ \frac{- 1 - j}{1} ]\end{matrix} \} \\ {\hat{A}}_{1} = \sqrt{2} \{ \begin{matrix}[ \frac{1}{1} ] , [ \frac{1}{1} ] , [ \frac{- 1}{1} ] , [ \frac{j}{1} ] , \\ [ \frac{- j}{1} ] , [ \frac{1 + j}{1} ] , [ \frac{1 - j}{1} ] , [ \frac{- 1 + j}{1} ] , [ \frac{- 1 - j}{1} ]\end{matrix} \} \qquad Eqs . 16$$

Thus, the per stream CINR estimation method takes the form of the set of Eqs. 16:

$${CINR}_{0} ( H ) = {min}_{e ∈ {\hat{A}}_{0}} \frac{{‖ He ‖}^{2}}{2 {ρ}^{2}} \\ {CINR}_{1} ( H ) = {min}_{e ∈ {\hat{A}}_{1}} \frac{{‖ He ‖}^{2}}{2 {ρ}^{2}} \qquad Eqs . 17$$

Therefore, the joint CINR (for the case of vertical SM) is provided by of Eq. 18:

$$CINR ( H ) = {min}_{e ∈ {\hat{A}}_{0} ⋃ {\hat{A}}_{1}} \frac{{‖ He ‖}^{2}}{2 {ρ}^{2}} = min [ \begin{matrix}{CINR}_{0} ( H ) , \\ {CINR}_{1} ( H )\end{matrix} ] \qquad Eq . 18$$

The following key points are emphasized:

(1) The proposed method is consistent with the linear decoder CINR in the case the columns of H are orthogonal (where the linear decoder is optimal).

$$H = [ \begin{matrix}1 & 0 \\ 1 & 0\end{matrix} ]$$

Thus, considering (ill conditioned) matrix 18:
the CINR of stream 0 is

$$\frac{2}{{ρ}^{2}} ,$$

and the CINR of stream 1 is 0.

It is appreciated that this result is obtained from the proposed method, as implied from the first elements in A₀ and A₁ respectively.

(2) From implementation point of view, the proposed CINR algorithm is best implemented through the ML decoder itself. It is appreciated that the minimum of the cost functional ∥He∥² may be computed using the kernel of the ML algorithm

$${min}_{s ∈ {QAM}^{2}} {‖ y - Hs ‖}^{2}$$

$$where$$

$$y = 0 and s = e .$$

The two per tone CINR metrics are tested on vertical SM on constant fading channel, defined by randomly generated channel matrix with given correlation (from 0 to 1 with step 0.1). White noise is added to the product according to SNR.

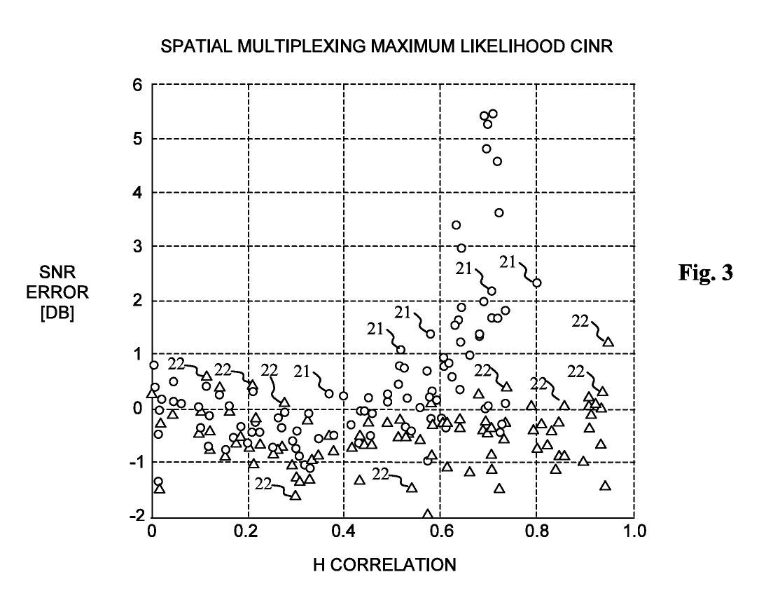

Reference is now made to FIG. 3, which is a simplified graphical illustration of CINR metrics according to a preferred embodiment of the present invention, compared with standard CINR.

The random source bits are modulated and passed through the channel. For every channel correlation point and CINR point, BER (bit error rate) and the two CINR estimators are measured. Since the fading channel being used is constant, the measured CINR should be related to measured BER according to the BER(CINR) dependency in an AWGN channel. Bearing in mind the above arguments, the CINR measurement error is defined as the difference between the measured CINR and the CINR value that corresponds to the measured BER in an AWGN channel. The CINR error is measured about the working point (BER 1E-3 to 1E-5).

In FIG. 3, circles, such as circle 21, represent standard CINR results calculated according to Eqs. 3-5, and triangles, such as triangle 22, represent CINR calculated based on Eqs. 16-18.

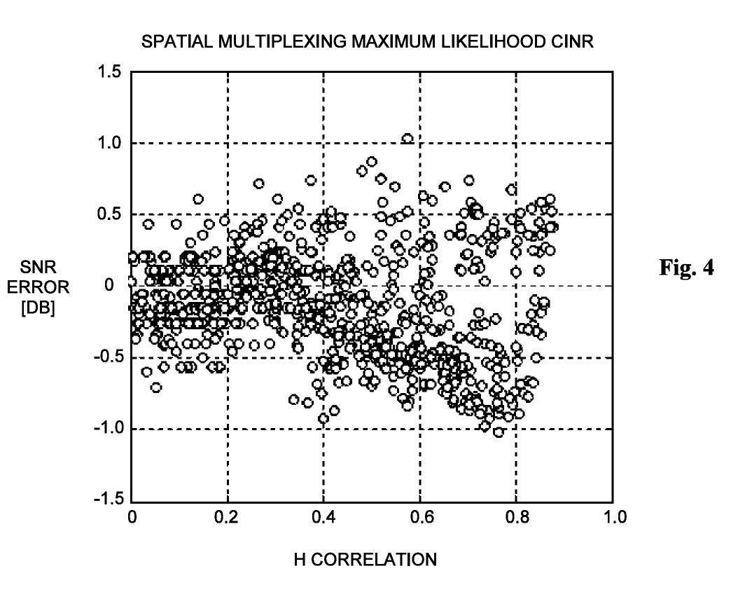

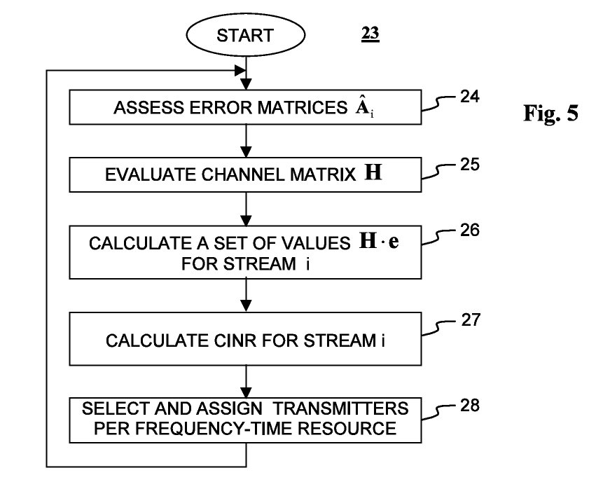

Reference is now made to FIG. 4, which is a simplified graphical illustration of CINR accuracy for QAM16 according to a preferred embodiment of the present invention.

The CINR derivation in above refers to QPSK modulation. The same derivation may be applied to the QAM16 and QAM64. In higher modulations there are more transition options, however the QPSK transitions sets A₀ and A₁ are good enough approximations for the QAM16/64 transition sets, as can be seen from FIG. 4 for the case of QAM16.

Reference is now made to FIG. 5, which is a simplified flow diagram of a process 23 of calculating CINR for a stream in a multi-stream communication system according to a preferred embodiment of the present invention.

The process described by the flow diagram of FIG. 5 is preferably implemented by the estimator 11 of FIG. 1A or 1B, which is preferably included at the receiver 14 side. The process 23 preferably calculates channel quality for a single selectable stream in multi-stream communication system.

The term “channel quality” refers to calculating CINR, or SINR, or SNR, etc.

The term “multi-stream communication system” refers to a communication system including a receiver using a plurality of antennas. For example, using a MIMO antenna system, such as the MIMO communication system 10 of FIGS. 1A and 1B.

The term “single selectable stream” refers to a selection of a single stream of the multi-stream communication system. The process calculates the channel quality for the selected stream. Preferably, the process can select and calculate channel quality for any stream of the multi-stream system.

The method for calculating channel quality preferably includes the following steps:
Calculating sets of values corresponding to errors in each stream. These sets are denoted as error matrices Âᵢ. Preferably, the error matrices Âᵢ are calculated offline (step 24).
Evaluating the channel matrix H, preferably online (step 25).
Calculating a set of values H·e for the i-th stream, where e denotes a matrix element in Âᵢ (step 26).
Calculating the CINR (or SINR or SNR) according to Eq. 19:

$$\begin{matrix}Eq . 19 & \\ {CINR}_{i} ( H ) = {min}_{e ∈ {\hat{A}}_{i}} \frac{{‖ He ‖}^{2}}{2 {ρ}^{2}} & ( step 27 )\end{matrix}$$

Optionally but preferably, the process can also perform selection and assignment of transmitters to the same frequency-time resource (step 28).

Offline, in this respect, means that the error matrices Aᵢ can be assessed for a MIMO configuration of [M×N] antennas in advance. The appropriate set of error matrices Aᵢ can thereafter be selected by the base-station 14 of FIG. 1A or 1B according to the MIMO antenna configuration.

Online, in this respect, means that the channel matrix H is evaluated in real-time, or near real-time, for example using pilot signals, and the CINR is calculated according to the evaluated channel matrix H.

It is appreciated that the receiver is typically a base-station receiving an uplink transmission and the channel quality is calculated for the uplink transmission. However, the receiver can also receive downlink transmissions, and the channel quality can be calculated for the downlink transmission.

It is appreciated that for high SNR, the CINR calculated according to Eq. 19 is practically independent of the modulation technique. Therefore, it is sufficient to assess the error matrices Aᵢ for a simple modulation technique, such as QPSK, and ten use the same error matrices Aᵢ for higher modulation techniques such as QAM16, QAM 64, etc.

It is also appreciated that the CINR calculation technique is useful for situations of mixed modulations. That is, for a MIMO system with streams of different modulation. For example, when the two transmitters 20 of FIG. 1B use different modulation techniques.

For transmitters transmitting a single stream each and in a horizontal manner, such as the transmitters 20 of FIG. 1B, the transmission is performed on the same frequency-time resources. The receiver 14, based on CINR calculations, can preferably select and assign the transmitters to use the same frequency-time resources. For example, in the multi-stream configuration of FIG. 1B, assuming that there are more than two transmitters 20, the process 23 can analyze the multi-stream system to select the best two transmitters 20 to use the same frequency-time resource. The analysis is based on the CINR calculated per stream in various combinations of transmitters assigned together to the same frequency-time resource. It is appreciated that several frequency-time resources can be assigned, and that more than two transmitters can be assigned to the same frequency-time resource.

It is expected that during the life of this patent many relevant Communication devices and systems will be developed and the scope of the terms herein, particularly of the terms “SNR”, “SINR”, “CINR”, MIMO, “spatial multiplexing” and “spatial diversity”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for calculating channel quality in a multi-stream communication system, the method comprising the step of:
calculating said channel quality for a selectable stream of said multi-stream communication system.

2. A method for calculating channel quality according to claim 1 additionally comprising:
estimation of at lest one set of error vectors comprising at least one transmission vector in which at least one element is erroneous; and
wherein said step of calculating said channel quality said estimation of at lest one set of error vectors.

3. A method for calculating channel quality according to claim 2 wherein said element comprises at least one of a bit, a baud, and a symbol.

4. A method for assigning a plurality of transmitters to a frequency-time resource in a multi-stream communication system, the method comprising the steps of:
calculating single-stream channel quality for a plurality of selectable streams of said multi-stream communication system;
selecting a frequency-time resource; and
assigning a plurality of transmitters to said frequency-time resource according to their channel quality.

5. A method for calculating channel quality according to claim 4, wherein said channel quality comprises at least one of:
signal to noise ratio (SNR);
Carrier to Interference-plus-Noise Ratio (CINR); and
Signal to Interference-plus-Noise Ratio (SINR).

6. A method for calculating channel quality according to claim 1, wherein said receiver receives said multi-stream signal in at least one of:
the uplink; and
the downlink.

7. A method for calculating channel quality according to claim 1, wherein said multi-stream communication system comprises at least one of:
a Multi-Input-Multi-Output (MIMO) technology;
a spatial diversity technology; and
a spatial multiplexing technology.

8. A method for calculating channel quality according to claim 4, wherein said step of calculating said channel quality comprises the step of:
calculating sets of values corresponding to errors in each stream; and
constructing at lest one set of error vectors (Âᵢ) from said values.

9. A method for calculating channel quality according to claim 1, wherein said step of calculating said channel quality comprises the steps of:
estimating channel response for each antenna; and
constructing channel matrix (H) from said channel responses.

10. A method for calculating channel quality according to claim 9, wherein said step of calculating said channel quality comprises the steps of:
calculating a set of values H·e for the i-th stream, where e denotes an element of said at lest one set of error vectors Âᵢ; and
Calculating said CINR for said selectable stream i according to:
$${CINR}_{i} ( H ) = {min}_{e ∈ {\hat{A}}_{i}} \frac{{‖ He ‖}^{2}}{2 {ρ}^{2}}$$

11. A method for calculating channel quality according to claim 1, wherein said multi-stream communication system comprises a plurality of user terminals, wherein each of said user-terminals transmits a single stream, and wherein said multi-stream signal comprises said single streams transmitted by said plurality of user-terminals.

12. A method for calculating channel quality according to claim 11 wherein at least two of said plurality of user-terminals use same frequency-time resource.

13. A method for calculating channel quality according to claim 12 additionally comprising at least one of the steps of:
selecting said user-terminals using said same frequency-time resources; and
selecting said frequency-time resources for use by said plurality of user-terminals.

14. A method for calculating channel quality according to claim 12 wherein said receiver performs at least one of said additional steps.

15. A method for calculating channel quality according to claim 8;
wherein said channel quality is calculated for a plurality of channels in a vertical spatial multiplexing situation; and
wherein said step of calculating said channel quality comprises the steps of:
calculating a set of values H·e for the i-th stream, where e denotes an element of said at lest one set of error vectors Âᵢ; and
calculating said CINR for said selectable stream i according to:
CINR(H)=min[CINR₀(H),CINR₁(H)]
